(19) United States
(12) Patent Application Publication
(10) Pub. No.: US 2024/0101453 A1
(43) Pub. Date: Mar. 28, 2024

(54) BIOELECTROCHEMICAL SYSTEM FOR WATER DEIONIZATION AND DESALINATION, WASTEWATER TREATMENT AND ENERGY RECOVERY

(71) Applicant: San Diego State University (SDSU) Foundation, dba San Diego State University Research Foundation, San Diego, CA (US)

(72) Inventors: Tyler MYERS, San Diego, CA (US); Christine M. DYKSTRA, San Diego, CA (US)

(21) Appl. No.: 17/952,157

(22) Filed: Sep. 23, 2022

Related U.S. Application Data
(60) Provisional application No. 63/247,475, filed on Sep. 23, 2021.

(51) Int. Cl. C02F 3/00; C02F 3/34

(52) U.S. Cl. CPC C02F 3/005; C02F 3/341; C02F 2103/08; C02F 2201/003; C02F 2201/46115; C02F 2203/006

(57) ABSTRACT

In alternative embodiments, provided are BioElectrochemical Systems (BESs) and methods using them for removing ionic compounds from water, treating organics in wastewater, and for energy recovery from the conversion of CO₂ to CH₄ in an anaerobic setting, for example, for biogas upgrading, or the production of H₂ from water electrolysis. In alternative embodiments, provided are products of manufacture that are anoxic BioElectrochemical Systems (BES) for ion removal, energy recovery by the conversion of CO₂ to CH₄, or by the production of H₂ from water electrolysis wastewater treatment and/or biogas upgrading of CO₂ to CH₄. In alternative embodiments, a bioanode is inoculated with an engineered microbial community of natural occurring bacteria in the site wastewater. In alternative embodiments, the biocathode is inoculated with a methanogenic community or engineered microbes for chemical reduction and/or plastic degradation.

### RELATED APPLICATIONS

This U.S. Utility patent application claims the benefit of priority under 35 U.S.C. § 119(e) of U.S. Provisional Application Ser. No. (USSN) 63/247,475, filed Sep. 23, 2021. The aforementioned application is expressly incorporated herein by reference in its entirety and for all purposes.

### TECHNICAL FIELD

This invention generally relates to the fields of bioremediation, wastewater treatment, bioelectrochemical systems, and water desalination. Specifically, provided are BioElectrochemical Systems (BESs) and methods using them for removing ionic compounds from water, treating organics in wastewater, and for energy recovery from the conversion of CO₂ to CH₄ in an anaerobic setting, for example, for biogas upgrading, or the production of H₂ from water electrolysis. In alternative embodiments, provided are products of manufacture that are anoxic BioElectrochemical Systems (BES) for ion removal, energy recovery by the conversion of CO₂ to CH₄, or by the production of H₂ from water electrolysis wastewater treatment and/or biogas upgrading of CO₂ to CH₄. In alternative embodiments, a bioanode is inoculated with an engineered microbial community of natural occurring bacteria in the site wastewater. In alternative embodiments, the biocathode is inoculated with a methanogenic community or engineered microbes for chemical reduction and/or plastic degradation.

### BACKGROUND

A BioElectrochemical System (BES) uses living microbial communities (for example, Bacteria, Archaea) and tailors a bioreactor environment to promote processes such as the generation of current, microbial metabolisms, the production of electrochemically active proteins and/or redox reactions.

Many BESs lack the utilization of multiple selective membranes and novel configurations for methods like desalination and contamination removal and concentration. Additionally, aerobic systems that exist use oxygen from ambient air as the main electron acceptor, whereas electron conservation may be better achieved in hypoxic or anoxic conditions. Therefore, what is needed are systems and techniques that overcome the above-mentioned disadvantages.

### SUMMARY

In alternative embodiments, provided are products of manufacture that are anoxic and/or anaerobic BioElectrochemical Systems (BESs) for water deionization and desalination, and/or wastewater treatment, and/or production of a chemically-reduced cathode product, such as CH₄ from CO₂. In alternative embodiments, a bioanode is inoculated with an engineered microbial community of exoelectrogenic microbes or with natural occurring microbes in the site wastewater. In alternative embodiments, the biocathode is inoculated with a methanogenic community, a mixed microbial community, cultures containing exoelectrogenic, methanogenic, or other species, or engineered microbes for enhanced system performance.

In alternative embodiments, provided are products of manufacture that are anaerobic BioElectrochemical Systems (BESs) for salt water desalination, wastewater treatment and/or conversion of CO₂ to CH₄. In alternative embodiments, a bioanode is inoculated with an engineered microbial community of natural occurring bacteria in the site wastewater.

In alternative embodiments, the biocathode is inoculated with a methanogenic community or engineered microbes for plastic degradation. The cathode may also be abiotic for simplicity of design. In alternative embodiments, the BES as provided herein comprises a middle desalination chamber that can be separated from the anode via an anion exchange membrane, or equivalent, and can be separated from the cathode via a proton exchange membrane, or equivalent. In alternative embodiments, an applied voltage is applied across the reactor for enhancing the desalination or biological processes. In alternative embodiments, the BES systems as provided herein are a batch system or continuous flow system.

In alternative embodiments, provided are methods for oxidizing a raw or pretreated wastewater through a biological or microbial community in an anode for the use of biogas upgrading in a biocathode and/or the removal of ions in a chamber separated by a membrane(s), comprising use of a product of manufacture, system or apparatus as provided herein.

In alternative embodiments, provided are methods for oxidizing a raw or pretreated wastewater using a biological or microbial community in an anode, and for the use of CO₂ conversion to CH₄ in a biocathode, and/or the removal of ions in a chamber separated by a membrane(s), comprising use of a product of manufacture, system or apparatus as provided herein.

In alternative embodiments, provided are methods for oxidizing the raw or pretreated wastewater through a biological or microbial community in an anode and for the removal of ions in a chamber separated by a membrane(s), using an abiotic cathode, comprising use of a product of manufacture, system or apparatus as provided herein.

In alternative embodiments, provided are methods for oxidizing the raw or pretreated wastewater through a biological or microbial community in an anode for the use of biogas upgrading and/or CO₂ conversion to CH₄ in a biocathode and/or the concentration of ions in a chamber separated by a membrane(s), comprising use of a product of manufacture, system or apparatus as provided herein.

In alternative embodiments, provided are methods for oxidizing the raw or pretreated wastewater through a biological or microbial community in an anode for the concentration of ions in a chamber separated by a membrane(s), using an abiotic cathode, comprising use of a product of manufacture, system or apparatus as provided herein.

In alternative embodiments, provided are products of manufacture, a system or an apparatus as set forth in FIG. 1, comprising an anode chamber, an ion removal chamber and a cathode chamber,

wherein the product of manufacture, system or apparatus has an ion removal configuration wherein an anion exchange membrane (AEM) is at an anode interface with the ion removal chamber and a cation exchange membrane (CEM) at a cathode interface with the ion removal chamber resulting in anions selectively flowing or migrating into the anode chamber and cations selectively flowing or migrating into the cathode chamber, thereby concentrating anions in the anode chamber and cations in the cathode chamber,

wherein the anode chamber and the cathode chamber comprises a biological or a microbial community,

and optionally the biological or microbial community comprises a plurality of living microbes, and optionally the plurality of living microbes comprise living Bacteria and/or Archaea, and optionally the biological or microbial community comprises methanogenic Bacteria and/or Archaea,

wherein the capture of electrons by the plurality of living microbes in the cathode chamber reduces CO₂ to CH₄,

wherein the anode chamber organic compounds are oxidized into biomass and CO₂,

wherein a wastewater (optionally treated or untreated, or raw or pretreated wastewater, or diluted or undiluted wastewater) flows into the anode chamber and treated water flows out of the anode chamber,

wherein a catholyte is flowed into the cathode chamber and CH₄ biofuel flows out of the cathode chamber,

wherein optionally input for the ion removal chamber comprises brackish water, seawater, saline water or a wastewater (optionally treated or untreated), and output from the ion removal chamber comprises deionized and/or desalinated water.

In alternative embodiments, provided are products of manufacture, a system or an apparatus as set forth in FIG. 2, comprising an anode chamber, an ion collection chamber and a cathode chamber,

wherein the product of manufacture, system or apparatus has an ion removal configuration wherein an anion exchange membrane (AEM) is at a cathode interface with the ion collection chamber and a cation exchange membrane (CEM) at an anode interface with the ion collection chamber resulting in anions and cations selectively flowing or migrating into the ion collection chamber, thereby concentrating ions in the ion collection chamber,

wherein the anode chamber and the cathode chamber comprises a biological or a microbial community,

and optionally the biological or microbial community comprises a plurality of living microbes, and optionally the plurality of living microbes comprise living Bacteria and/or Archaea, and optionally the microbial community comprises methanogenic Bacteria and/or Archaea,

wherein the capture of electrons by the plurality of living microbes in the cathode chamber reduces CO₂ to CH₄,

wherein the anode chamber organic compounds are oxidized into biomass and CO₂,

wherein a wastewater (optionally treated or untreated, or raw or pretreated wastewater, or diluted or undiluted wastewater) flows into the anode chamber and treated water flows out of the anode chamber,

wherein a catholyte is flowed into the cathode chamber and CH₄ biofuel flows out of the cathode chamber,

wherein optionally input for the ion collection chamber comprises brackish water, seawater, saline water or a wastewater (optionally treated or untreated), and output from the ion collection chamber comprises concentrated ions.

In alternative embodiments of products of manufacture, systems or apparatus as provided herein:

wherein optionally the cathode is held at a constant electrical potential, or a substantially constant electrical potential, and the product of manufacture, system or apparatus comprises and is operably linked to (to maintain a substantially constant cathode potential) a potentiostat or any instrument designed to control the working electrode's potential in the electrode electrochemical cell, and a power supply or a photovoltaics device, or the product of manufacture, system or apparatus comprises a connection to an electrical grid to supply power to maintain a substantially constant electrical potential,

and optionally the product of manufacture, system or apparatus runs, or is configured to set to run or operate, at operating voltages comprising:
(i) a cathode potential ranging from between about −0.2 V vs. Ag/AgCl to about −1.5 V vs. Ag/AgCl, optionally having an operating potential of about −0.7 V vs. Ag/AgCl, −0.6 V vs. Ag/AgCl or −0.5 V vs. Ag/AgCl;
(ii) an anode potential ranging from between about 0.0 V vs. Ag/AgCl to about 2.5 V vs. Ag/AgCl, optionally having an operating potential of about 1.2 V vs. Ag/AgCl, 1.1 V vs. Ag/AgCl or 1.3 V vs. Ag/AgCl; and/or
(iii) a cell potential ranging from between about 0.2 V to 5.0 V, optionally having an operating potential of about 2.5 V, 2.4 V, 2.6 V, 2.3 V or 2.7 V.

In alternative embodiments the products of manufacture, systems or apparatus as provided herein are connected directly or remotely to a computer system configured to control and operate BES, optionally comprising controls to modify the cathode potential, the anode potential and/or the cell potential.

In alternative embodiments, provided are methods for oxidizing raw or pretreated wastewater comprising:
contacting raw or pretreated wastewater with a biological or microbial community in an anode environment using a product of manufacture, system or apparatus as provided herein,
wherein the biological or microbial community comprises a plurality of living microbes, and optionally the plurality of living microbes comprise Bacteria and/or Archaea,
and biogas or CO₂ is upgraded to generate CH₄ or biofuel in a biocathode and/or the removal of ions in a chamber separated by a membrane(s).

In alternative embodiments, provided are methods for oxidizing raw or pretreated wastewater through a biological or microbial community in an anode for the use of chemical reduction in a biocathode and/or the removal of ions in a chamber separated by a membrane(s) comprising:
contacting raw or pretreated wastewater with a biological or microbial community in an anode environment using a product of manufacture, system or apparatus as provided herein.

In alternative embodiments, provided are methods for oxidizing the raw or pretreated wastewater through a biological or microbial community in an anode for the removal of ions in a chamber separated by a membrane(s), comprising:
contacting raw or pretreated wastewater with a biological or microbial community in an anode environment using a product of manufacture, system or apparatus as provided herein.

In alternative embodiments, provided are methods for oxidizing the raw or pretreated wastewater through a biological or microbial community in an anode for the use of biogas upgrading in a biocathode and/or the concentration of ions in a chamber separated by a membrane(s) comprising:
contacting raw or pretreated wastewater with a biological or microbial community in an anode environment using a product of manufacture, system or apparatus as provided herein.

In alternative embodiments, provided are methods for oxidizing the raw or pretreated wastewater through a biological or microbial community in an anode for the concentration of ions in a chamber separated by a membrane(s), comprising:
contacting raw or pretreated wastewater with a biological or microbial community in an anode environment using a product of manufacture, system or apparatus as provided herein.

In alternative embodiments of devices as provided herein:
a mixed culture of bacteria and/or Archaea is in the anode;
a mixed culture of bacteria and/or Archaea is in the cathode;
a pure culture, or substantially pure culture, of bacteria or Archaea are in the anode (wherein substantially is between about 90% and 99% pure);
a pure culture, or substantially pure culture, of bacteria or Archaea are in the cathode (wherein substantially is between about 90% and 99% pure);
the anode oxidizes a wastewater, or the anode oxidizes a solution comprising wastewater, or substantially comprising a wastewater (wherein substantially is between about 90% and 99%);
the anode oxidizes a chemical, or the anode oxidizes a solution comprising a chemical, or substantially comprising a chemical (wherein substantially is between about 90% and 99%);
the cathode produces methane (CH₄) from carbon dioxide (CO₂);
the cathode produces hydrogen gas, or H₂, from water electrolysis;
the cathode produces a carbon-based compound, optionally an alkane or an alkene or an alcohol, or methanol, acetate, methane, ethane, ethanol, butanol, butane, and the like;
the cathode produces ammonium, ethylamine, mehylamine or any nitrogen-based compound;
the ion removal chamber removes ions with a +1, +2, and/or +3 valence state;
as exemplary BES system as provided herein is operated with or without cation and anion exchange membranes; and/or
the cathode contains or comprises an abiotic catalyst (for example, platinum) for water electrolysis.

Alternative embodiments of devices as provided herein comprise alternative components as listed in Table 1:

TABLE 1

| Modification | Option 1 | Option 2 | Option 3 | Option 4 |
|---|---|---|---|---|
| Microbial | Mixed | Pure cultures | — | — |
| community | | | | |
| Anode product | Oxidized | CO₂ | Oxidized | |
| | wastewater | | chemical | |
| Cathode product | CH4 | Other C-based | H₂ | NH₄⁺ or other N- |
| | | compounds (e.g., | | based compounds |
| | | CH₃OH | | (e.g., NH₄OH, |
| | | methanol, acetate | | etc.) |
| | | (CH₃COOH), etc | | |
| IRC ions for | +1 valence (e.g., | +2 valence | +3 valence | |
| separation | NaCl→ Na⁺ + Cl⁻) | | | |
| Membrane | With membrance | Without | | |
| | | membrance | | |
| Operation | Batch | Continuous flow | | |
| Biotic or abiotic | Biotic | Abiotic | | |
| anode | | | | |
| Biotic or abiotic | Biotic | Abiotic | | |
| cathode | | | | |

The details of one or more exemplary embodiments of the invention are set forth in the accompanying drawings and the description below. Other features, objects, and advantages of the invention will be apparent from the description and drawings, and from the claims.

All publications, patents, patent applications cited herein are hereby expressly incorporated by reference in their entireties for all purposes.

### DESCRIPTION OF DRAWINGS

The patent or application file contains at least one drawing executed in color. Copies of this patent or patent application publication with color drawing(s) will be provided by the Office upon request and payment of the necessary fee.

FIG. 1 schematically illustrates an exemplary BioElectrochemical System (BES) as provided herein where the ion removal configuration for the BES uses an anion exchange membrane (AEM) at the anode interface with the ion removal chamber and a cation exchange membrane (CEM) at the cathode interface, as discussed in further detail, below.

FIG. 2 schematically illustrates an exemplary BioElectrochemical System (BES) system as provided herein using a CEM at the anode interface with the ion removal chamber and an AEM at the cathode interface, as discussed in further detail, below.

FIG. 3 (or FIG. 1 of Example 2): illustrates a picture of an exemplary three-chamber d-BioElectrochemical System (dBES), setup, with bioanode (left), ion removal chamber (TRC) (center), and biocathode (right).

FIG. 4A-B (or FIG. 2A-B of Example 2): graphically illustrate time series of the cell, anode, and cathode potentials (V_{cell}, V_{anode}, and V_{cathode}, respectively) in dBES1:

FIG. 4A graphically illustrates data from a study where V_{cathode} was held constant at −0.8 V vs. Ag/AgCl between day 0 and 56 and V_{cell} was held constant at 2.5 V between day 61 and 75; and

FIG. 4B: graphically illustrates the conductivity per cycle (mS/cm) from the study of FIG. 4A, showing the initial (black, or left bar) and final (gray, or right bar) conductivity in the exemplary dBES1 IRC over eleven feeding cycles.

FIG. 5 (or FIG. 3 of Example 2) graphically illustrates a time series of Veen and biocathode methane production in the exemplary d-BioElectrochemical System-1 (dBES1), showing on the left (using the bars) Vcell as a function of days and on the right methane in mmols (using the line) as a function of days.

FIG. 6A-B (or FIG. 4A-B of Example 2) graphically illustrate a time series of V_{anode} and V_{cathode} for exemplary dBES2 and dBES3 during operation:

FIG. 6A with a fixed cell potential of 2.5 V (A), with voltage vs Ag/AgCl; and

FIG. 6B with a system current, with current in mA as a function of hours;

and feeding and IRC replacement occurred at 0, 50.9, 73.28, 99.48, and 123.85 hours.

FIG. 7 (or FIG. 5, of Example 2) graphically illustrates average initial and final conductivity for dBES2 and dBES3 feeding cycles with various salts and initial salt concentrations in the IRC: anode conductivity (black, or left, bar); IRC conductivity (hatched-lined, or middle, bar); cathode conductivity (checked, or right, bar), and the IRC contained DI with initial concentrations of 10 g/L NH₄Cl (Cycle #1), 12 g/L NaCl (Cycle #2), 8 g/L NaCl (Cycle #3), 6 g/L NaCl (Cycle #4), or 20 mM phosphate buffer (Cycle #5).

FIG. 8A-B (or FIG. 6A-B of Example 2) graphically illustrate final cathode headspace gas composition for Cycles #1-5, as shown in terms of CO₂ (FIG. 8A) and CH₄ (FIG. 8B) for dBES2 (blue, or solid shaded, or left bar) and dBES3 (checked, or right bar), with total mmol as a function of days.

The drawings set forth herein are illustrative of exemplary embodiments provided herein and are not meant to limit the scope of the invention as encompassed by the claims.

Like reference symbols in the various drawings indicate like elements.

### DETAILED DESCRIPTION

In alternative embodiments, provided are BioElectrochemical Systems (BESs) and methods using them for removing ionic compounds from water, treating organics in wastewater, and for the conversion of CO₂ to CH₄ in an anaerobic/anoxic setting, and for biogas upgrading. In alternative embodiments, BESs as provided herein are modular BES, BES configuration and methods for contamination removal and energy recovery from the conversion of CO₂ to CH₄, biogas upgrading and/or the generation of current in a BES.

In alternative embodiments, BES and systems as provided herein use untreated wastewater as an input source, or inoculum.

In alternative embodiments, BES and systems as provided herein use a waste stream for the anode of the BES or a series of modular BESs. In alternative embodiments, the anode is held at an applied potential for optimized microbial behavior. The anode may remain abiotic in some configurations. In alternative embodiments, a naturally occurring microbial community is used in the anode to generate current from the contents of wastewater. Similarly, the raw wastewater may be pretreated to remove solid particulates and then used as the inoculum and anode waste stream.

In alternative embodiments, the output of a BES as provided herein is treated wastewater through the conversion of the contents of the wastewater or through the removal of the components through the selective membranes.

In alternative embodiments, an adjacent modular ion collection/removal chamber is separated from the anode via a permeable exchange membrane (for example, cation, anion and/or proton). The ion collection/removal chamber can also be separated from a modular biocathode or modular abiotic cathode via a permeable exchange membrane (for example, cation, anion and/or proton).

In alternative embodiments, the modular ion collection/removal chamber is configured to either concentrate ionic conductivity and/or concentration, and/or to increase or concentrate ammonium, nitrogen, phosphate, phosphorus, sodium, chloride, volatile fatty acids (VFAs), chemical oxygen demand (COD), and the like, in the ion collection/removal chamber or the anode/cathode chambers depending on the configuration of the permeable membranes. In alternative embodiments, the output of the ion collection/removal chamber is either treated water with a decrease in the ionic conductivity/concentration, ammonium, nitrogen, phosphate, phosphorus, sodium, chloride, VFAs, COD, and the like, or nutrient/resource rich water with an increase in ionic conductivity/concentration, ammonium, nitrogen, phosphate, phosphorus, sodium, chloride, VFAs, COD, as the like. Dependent upon the configuration of the BES, raw wastewater, pretreated wastewater, brackish water, and/or saline water may be used as inoculum or waste stream.

In alternative embodiments, the cathode chamber is used as an electron donor for processes including the biogas upgrading, and/or for the conversion of CO₂ to CH₄, via inoculation with a single methanogenic species or a mixed methanogenic culture in anoxic conditions. The cathode may also be abiotic in anoxic, hypoxic or aerobic conditions. The cathode may be held at an applied potential for optimized microbial behavior.

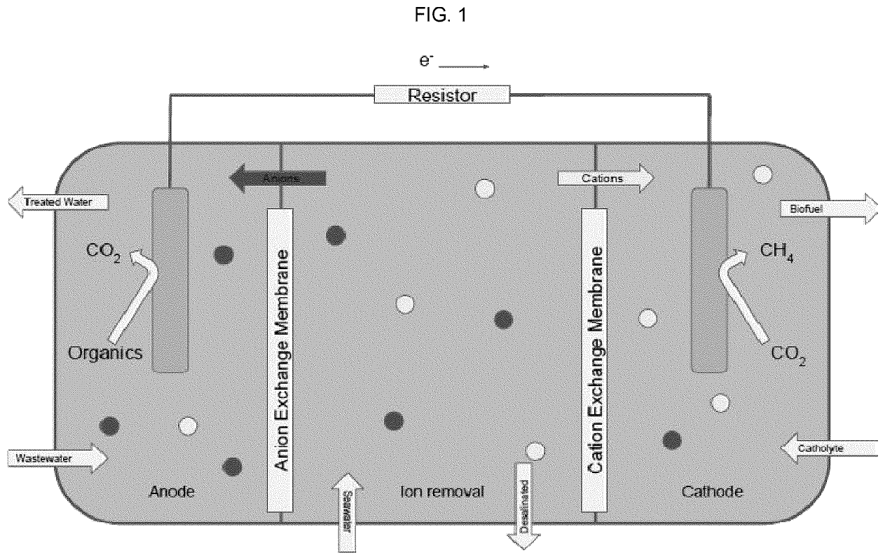

FIG. 1 schematically illustrates an exemplary BES system as provided herein where the ion removal configuration for the BES uses an anion exchange membrane (AEM) at the anode interface with the ion removal chamber and a cation exchange membrane (CEM) at the cathode interface. Anions (in red) and cations (in yellow) are able to selectively migrate across the membranes, thus concentrating the cations in the cathode and anions in the anode. This process is driven by the generation of current from a microbial community (optionally comprising a plurality of living microbes such as Bacteria and/or Archaea), and the capture of the electrons which reduce CO₂ to CH₄. In this exemplary system, the anode uses a bioelectrochemical reaction from the microbial community to oxidize organics into biomass and CO₂. In this exemplary system, the input can be wastewater at varying strengths and pretreatments and the output can be treated wastewater. Brackish water, seawater, saline water and other wastewaters can be used as the input for the ion removal chamber. In this exemplary system, after treatment and the selective migration of ions due to microbial processes in the cathode and anode, deionized water (desalination or ion removal) is the output.

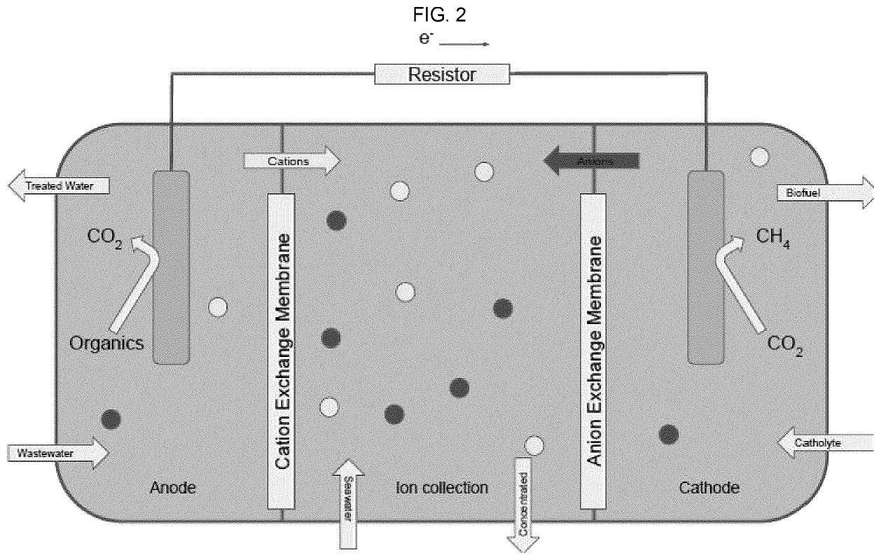

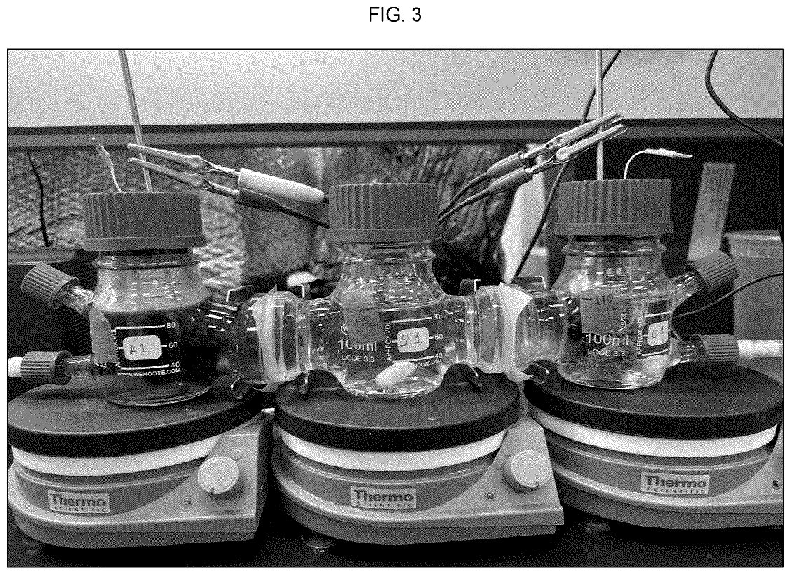

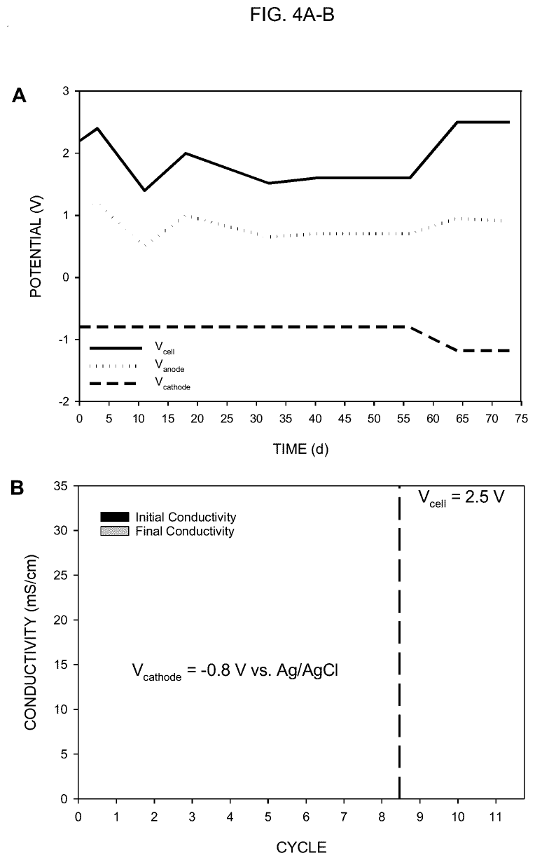

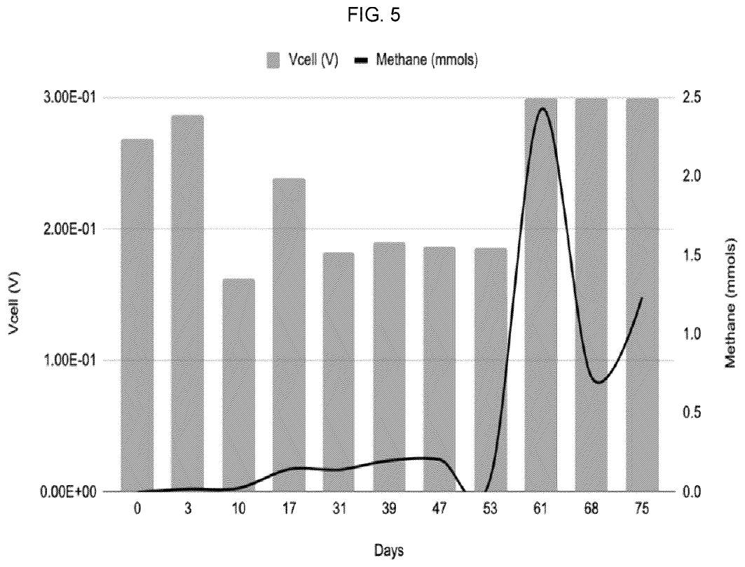

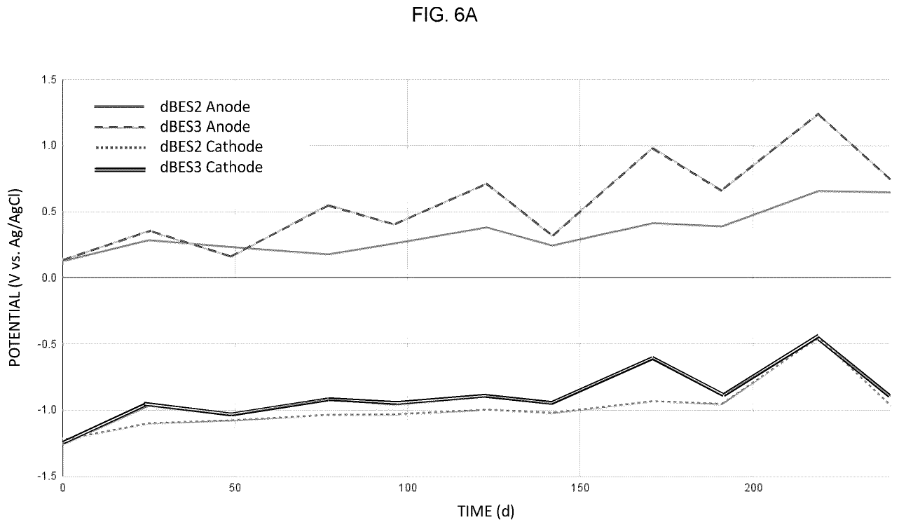

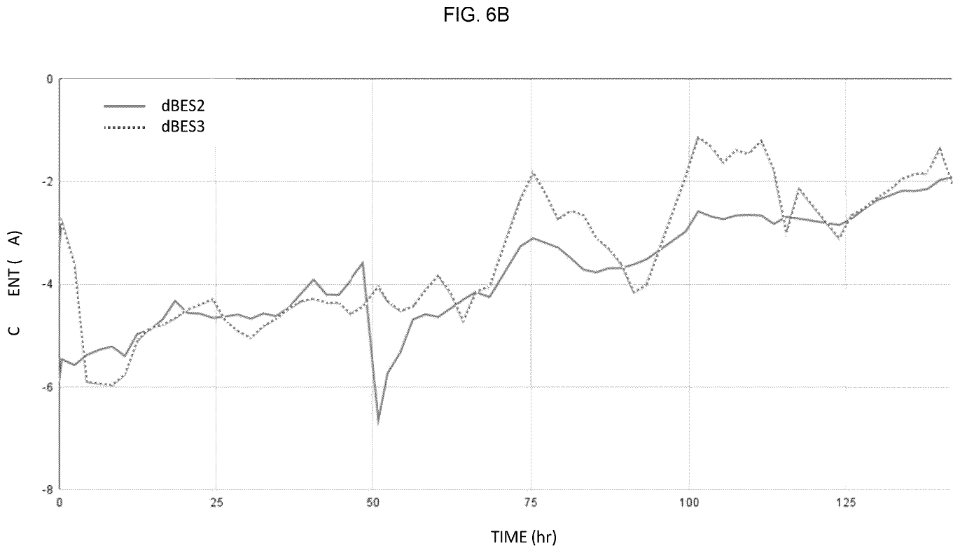

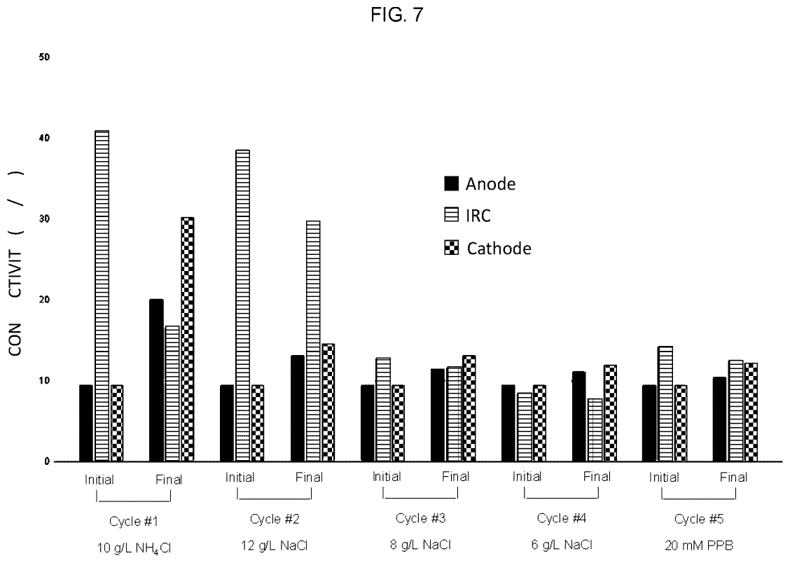

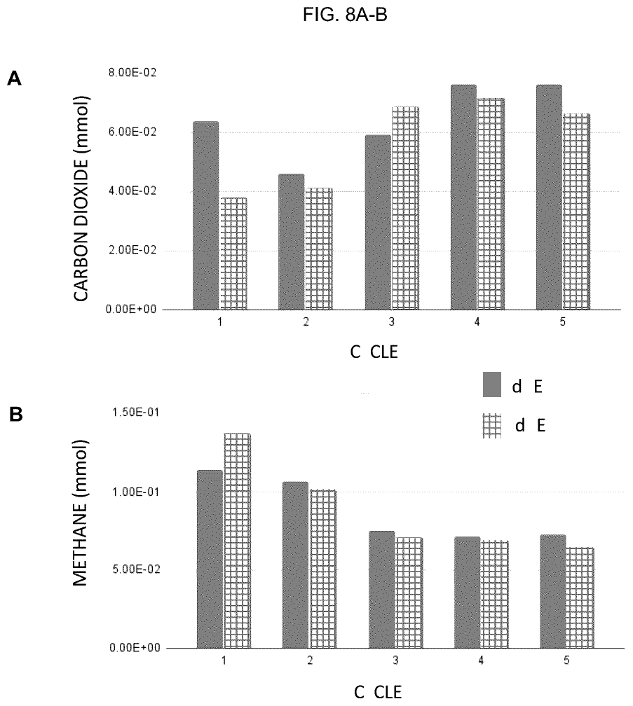

FIG. 2 schematically illustrates an exemplary BES system as provided herein where the ion collection configuration for the BES uses CEM at the anode interface with the ion removal chamber and an AEM at the cathode interface. Anions (in red) and cations (in yellow) are able to selectively migrate across the membranes, thus concentrating the cations and anions in the ion collection chamber. This process is driven by the selectively permeable membranes and the potential microbial communities in the cathode and anode. The anode input can be wastewater with high concentrations of cations and the cathode input can be wastewater with high concentrations of anions. Output from both the cathode and anode can be treated/deionized water. The input for the ion collection chamber can be wastewater, seawater, brackish water or clean water, or any desired medium for the collection of the nutrients from the ion collection chamber.

Products of Manufacture and Kits

Provided are products of manufacture and kits for practicing BES systems and methods as provided herein, including optionally a potentiostat or any instrument designed to control the working electrode's potential in the electrode electrochemical cell, and a power supply or a photovoltaics device, or the product of manufacture, system or apparatus comprises a connection to an electrical grid to supply power to maintain a substantially constant electrical potential; and optionally, products of manufacture and kits can further comprise instructions for practicing methods as provided herein.

Any of the above aspects and embodiments can be combined with any other aspect or embodiment as disclosed here in the Summary, Figures and/or Detailed Description sections.

As used in this specification and the claims, the singular forms “a,” “an” and “the” include plural referents unless the context clearly dictates otherwise.

Unless specifically stated or obvious from context, as used herein, the term “or” is understood to be inclusive and covers both “or” and “and”.

Unless specifically stated or obvious from context, as used herein, the term “about” is understood as within a range of normal tolerance in the art, for example within 2 standard deviations of the mean. About (use of the term “about”) can be understood as within 20%, 19%, 18%, 17%, 16%, 15%, 14%, 13%, 12% 11%, 10%, 9%, 8%, 7% 6%, 5%, 4%, 3%, 2%, 1%, 0.5%, 0.1%, 0.05%, or 0.01% of the stated value. Unless otherwise clear from the context, all numerical values provided herein are modified by the term “about.”

Unless specifically stated or obvious from context, as used herein, the terms “substantially all”, “substantially most of”, “substantially all of” or “majority of” encompass at least about 75%, 80%, 85%, 90%, 91%, 92%, 93%, 94%, 95%, 96%, 97%, 98%, 99% or 99.5%, or more of a referenced amount of a composition.

The entirety of each patent, patent application, publication and document referenced herein hereby is incorporated by reference. Citation of the above patents, patent applications, publications and documents is not an admission that any of the foregoing is pertinent prior art, nor does it constitute any admission as to the contents or date of these publications or documents. Incorporation by reference of these documents, standing alone, should not be construed as an assertion or admission that any portion of the contents of any document is considered to be essential material for satisfying any national or regional statutory disclosure requirement for patent applications. Notwithstanding, the right is reserved for relying upon any of such documents, where appropriate, for providing material deemed essential to the claimed subject matter by an examining authority or court.

Modifications may be made to the foregoing without departing from the basic aspects of the invention. Although the invention has been described in substantial detail with reference to one or more specific embodiments, those of ordinary skill in the art will recognize that changes may be made to the embodiments specifically disclosed in this application, and yet these modifications and improvements are within the scope and spirit of the invention. The invention illustratively described herein suitably may be practiced in the absence of any element(s) not specifically disclosed herein. Thus, for example, in each instance herein any of the terms “comprising”, “consisting essentially of”, and “consisting of” may be replaced with either of the other two terms. Thus, the terms and expressions which have been employed are used as terms of description and not of limitation, equivalents of the features shown and described, or portions thereof, are not excluded, and it is recognized that various modifications are possible within the scope of the invention. Embodiments of the invention are set forth in the following claims.

The invention will be further described with reference to the examples described herein; however, it is to be understood that the invention is not limited to such examples.

### EXAMPLES

### Example 1: Exemplary Product of Manufacture to Generate Biofuels

This example demonstrates that products of manufacture as provided herein are effective and can be used for saltwater desalination, wastewater treatment and/or biogas upgrading of CO₂ to CH₄.

An exemplary reactor as provided herein comprises a glass bottle reactor consisting of three chambers. The chambers are separated by an anion exchange membrane (AEM) and a cathode exchange membrane (CEM) as depicted in FIG. 1. The volumes for the anode, ion removal and cathode chamber were 140 mL, 190 mL, and 140 mL, respectively. The glassware bottles were closed with rubber stoppers, with the anode and cathode chambers having a Ag/AgCl reference electrode and stainless steel rod attached to the rubber stopper. The reference electrode and stainless-steel electrode are positioned in the rubber stopper such that they are able to be submerged in the liquid media of the chamber, without touching the bottom of the reactor and while also leaving room for the anode and cathode to have a headspace for gas collection. A carbon felt is fastened to the stainless-steel electrode in the anode and cathode compartments for the support of electroactive microbial communities.

In this exemplary reactor, the anode and cathode were inoculated with microorganisms to accomplish organic material oxidation in the anode and the conversion of CO₂ to CH₄ in the cathode. The reactor was maintained on a batch media replacement weekly routine, filling the anode and cathode to 110 mL and the ion removal chamber to 145 mL.

All chambers were filled with a rich media containing: 14.2 g/L NaH₂PO₄·H₂O, 13.8 g/L Na₂HPO₄, 0.31 g/L NH₄Cl, 0.13 g/L KCl, 12.5 mL/L mineral stock (1.5 g/L nitrilotriacetic acid, 3 g/L MgSO₄·7H₂O, 0.5 g/L MnSO₄·H₂O, 1 g/L NaCl, 0.1 g/L FeSO₄·7H₂O, 0.1 g/L CoCl₂·6H₂O, 0.1 g/L CaCl₂, 0.1 g/L ZnSO₄·7H₂O, 0.01 g/mL CuSO₄·5H₂O, 0.01 g/L AlK(SO₄)₂·12H₂O, 0.01 g/L Na₂MnO₄·2H₂O), and 2.5 mL/L vitamin stock (0.01 g/L folic acid, 0.05 g/L pyridoxine hydrochloride, 0.025 g/L riboflavin, 0.01 biotin, 0.025 thiamine, 0.025 g/L nicotinic acid, 0.025 calcium pantothenate, 0.0005 g/L vitamin B12, 0.025 p-aminobenzoic acid, 0.025 thioctic acid).

On a weekly basis, media was replaced, and the anode was fed 3 mL of 0.1M sodium acetate then flushed N₂ gas. On the same feeding schedule, the ion removal chamber was flushed with N₂ gas, and the cathode chamber was flushed with CO₂ gas after the replacement of their media.

At the end of each 7-day feeding cycle and before the replacement of media, pressure was recorded using a pressure transducer. Voltage measurements were also taken for the potentials between the anode stainless-steel electrode and its Ag/AgCl reference electrode, the cathode stainless-steel electrode and its Ag/AgCl, and the cathode stainless-steel electrode and anode stainless-steel electrode. The composition of the headspace gas (CO₂, CH₄, H₂, N₂) from each chamber was recorded and analyzed via gas chromatography (GC) with thermal conductivity (TCD). pH and conductivity were recorded using pH and conductivity probes. Recorded data is presented in Table 1.

| | Initial ion | Final ion | | |
|---|---|---|---|---|
| | removal | removal | | |
| | chamber | chamber | Percent | Total mmol |
| | Conductivity | Conductivity | Ionic | CH4 from |
| Date | (mS/cm) | (mS/cm) | removal | CO2 |
| Apr. 9, 2021 | 10.81 | 2.4 | 77.80% | 0.00E+0 |
| Apr. 12, 2021 | 10.81 | 6.7 | 38.02% | 2.45E−03 |
| Apr. 19, 2021 | 10.81 | 10.02 | 7.31% | 3.01E−03 |
| Apr. 26, 2021 | 10.81 | 10.74 | 0.65% | 1.75E−02 |
| May 10, 2021 | 10.81 | 9.98 | 7.68% | 1.71E−02 |
| May 18, 2021 | 10.81 | 10.4 | 3.79% | 2.40E−02 |
| May 26, 2021 | 10.81 | 10.44 | 3.42% | 2.48E−02 |
| Jun. 1, 2021 | 10.81 | 10.38 | 3.98% | 1.06E−02 |
| Jun. 9, 2021 | 10.81 | 7.1 | 34.32% | 2.91E−01 |
| Jun. 16, 2021 | 10.81 | 7.1 | 34.32% | 8.74E−02 |
| Jun. 23, 2021 | 32.01 | 6.42 | 79.94% | 1.48E−01 |

Data provided in Table 1 demonstrate the efficacy of methods for deionization of the ion removal chamber and the conversion of CO₂ to CH₄ in a three-chamber bioreactor as provided herein. The initial and final conductivity of the ion removal chamber shows a decrease in ionic conductivity in the ion removal chamber over the course of a week ranging from 0.65% to 79.94% ionic removal upon optimization. Additionally, the cathode was flushed solely with CO₂, thus all CH₄ production over the week-long feeding cycle (total mmol CH₄ from CO₂) can be accredited to the microbial community in the cathode.

### Example 2: Exemplary Bioelectrochemical Systems for Desalination with Energy Recovery

This example demonstrates exemplary products of manufacture as provided herein, and that these products of manufacture are effective as bioelectrochemical systems for desalination with energy recovery.

Bioelectrochemical systems (BES) convert carbon dioxide (CO₂) to methane (CH₄), a carbon-neutral energy source, and produce a small electrical current through the use of applied microorganisms in the wastewater treatment process. The objective of this research is to develop the first comprehensive model of a BES, titled BESM1, to be employed in the fields of energy and nutrient recovery, groundwater monitoring, or chemical/pharmaceutical production. Previously, the only available models for this field of study are for anaerobic digestion, ADM1, or microbial fuel cells, therefore to establish a foundation for BESM1, data was collected in a laboratory for over six years from multiple BES reactors and utilized in an adapted modeling framework from ADM1. The collected data was used to incorporate initial conditions along with kinetic rates and organic compound production/transportation differentials to display a graphical visualization of the processes occurring in the system. Developed in Matlab, this model can be used as a mathematical optimization tool to predict outcomes based on various conditions (i.e., different gas compositions, applied potential, etc.). As a result, BESM1 determines ideal conditions for peak efficiency within BES technology that has yet to be modeled until now.

Energy-recovery BESs are typically operated with a fixed cathode potential (V_{cathode}) that is held at a sufficiently negative voltage (versus an adjacent reference electrode) to drive the desired cathode reaction (e.g., CO₂ to CH₄). This configuration allows for the anode potential (V_{anode}) to fluctuate. When active electrogenic microbes are present at the anode, the V_{anode} will increase and decrease in accordance with substrate availability. Subsequently, the overall cell potential (V_{cell}), which represents the voltage between the anode and cathode, will fluctuate in tandem with V_{anode}. Although this approach to applying a potential to the BES is effective for energy-recovery setups, it may not be ideal for a dBES because the driving force for ion separation is ionic charge attraction to the anode or cathode. Thus, an alternate approach is to operate the dBES with a fixed V_{cell}, which allows the V_{anode} and V_{cathode} to fluctuate in tandem but maintains a constant voltage between the anode and cathode. However, it is not known how the two applied potential configurations influence the rate of ion removal or the biocathode/bioanode processes in a dBES. Therefore, one objective of this study is to compare dBES performance when the potential is applied by holding either the V_{cathode} or V_{cell} constant.

Materials and Methods

BES Setup

Inoculated with S. oneidensis, anodes as provided and used herein degrade organics in wastewater to generate a current for biogas upgrading and desalination. The ion removal chamber (IRC) will take advantage of the voltage difference between the Anode and Cathode to deionize the chamber based on exchange membranes which selectively allow charged ions to move into the Anode or Cathode.

In the Cathode, M. maripaludis converts CO₂ into the biofuel CH₄, with potential downstream applications for gas to liquid biofuel production.

dBES1-IRC conductivities: 10.81 mS/cm or 32.01 mS/cm.

To better understand how two duplicate dBESs with a fixed cell potential of 2.5 V remove ions from water in the IRC that contains: i) 10 g/L NH₄Cl (conductivity 41.01 mS/cm) in Cycle #1; ii) 12 g/L NaCl (conductivity 38.55 mS/cm) in Cycle #2; iii) 8 g/L NaCl (conductivity 12.82 mS/cm) in Cycle #3; iv) 6 g/L NaCl (conductivity 8.49 mS/cm) in Cycle #4; and v) 20 g/L K₂HIPO₄ (conductivity 14.29 mS/cm) in Cycle #5. dBES2, dBES3-Feeding and IRC replacement at 0, 50.9, 73.28, 99.48, 123.85.

Cycle 1: 10 g/L NH₄Cl (41.01 mS/cm)

Cycle 2: 12 g/L NaCl (38.55 mS/cm)

Cycle 3: 8 g/L NaCl (12.82 mS/cm)

Cycle 4: 6 g/L NaCl (8.49 mS/cm)

Cycle 5: 20 g/L K₂HIPO₄ (14.29 mS/cm)

Results and Discussion

Effect on dBES1 performance of holding cathode or cell potential constant dBES1 was operated for a total of 11 consecutive cycles, with the initial cycle 3 days in length and the remaining cycles 7 days in length (Table 1). The first 8 cycles were operated by holding the cathode potential at a constant −0.80 V vs. Ag/AgCl, while the last 3 cycles were operated by holding the cell potential constant at 2.5 V. During the first dBES1 cycle, the ion removal chamber (IRC) achieved a 77% reduction in conductivity over the course of 3 days. However, the ion removal efficiency declined during the second cycle and third cycles, which only achieved 40% and 7% conductivity removal, respectively, over a 7 day period. The IRC achieved an ion removal efficiency that ranged between 2.1% and 7.5% for cycles 3 to 8. The resulting poor performance of the IRC was thought to be due to the fluctuation in V_{cell} over time. With a fixed V_{cathode}, V_{anode} and V_{cell} are allowed to fluctuate, which may result in a decline in the driving force for ion transport across an ion exchange membrane. The principle of electroneutrality in water requires that the rate of anion charge transport across one membrane (e.g., anions crossing an anion exchange membrane towards the anode) must be equal to the rate of cation charge transport across the opposite membrane (e.g., cations across a cation exchange membrane towards the cathode). Thus, the total rate of ion removal is limited by the slowest rate of charge transport (i.e., cations or anions) across a membrane.

The decline in IRC ion removal efficiency across cycles 1-3 (from 77% conductivity removal in Cycle 1 to 7% in Cycle 3) indicated a slowing rate of ion transport across the anion and cation exchange membranes following start up. Assuming the cation and anion exchange membranes facilitated a similar rate of charge transfer (and that overpotentials in the electrical circuit were perfectly balanced), the potential of the IRC bulk liquid was theoretically equal to the mean potential of the anode and cathode. For example, in a batch-fed dBES, if V_{cathode} was fixed at −0.80 V vs. Ag/AgCl, V_{anode} was +0.80 V vs. Ag/AgCl, and V_{cell} was 1.60 V, the potential in the well-mixed IRC bulk liquid would be 0.00 V vs. Ag/AgCl. The charge concentration gradient across the membrane drives ion transport; thus, when V_{cathode} is held constant, the decline in V_{anode} over time, often due to declining anode substrate availability, leads to a decline in V_{cell}, and a progressively slower rate of ion transport across the membrane.

With the dBES1 cathode potential fixed at −0.80 V vs. Ag/AgCl, the anode and cell potentials stabilized at 0.74±0.03 V vs. Ag/AgCl and 1.59±0.03 V, respectively (FIG. 2A), during Cycles 3 to 8.

During Cycles 9-11, dBES1 was operated with a 2.5 V cell potential (anode to cathode), instead of a fixed cathode potential. The theoretical median potential was 1.25 V for the IRC bulk liquid during these cycles, assuming that the cation and anion exchange membranes produced a similar rate of charge transfer and overpotentials in the electrical circuit were balanced.

### SUMMARY

Setting V_{cell} instead of V_{cathode} led to improvements in desalination and biocathode CH₄ production.
Higher V_{cell} voltages resulted in more deionization from the desalination cell.
A sufficient ratio of anode and cathode liquid volume to IRC liquid volume is important to avoid high ion concentrations in the anode and cathode, which may lead to disruption of the biological community. For example, small bioanode and biocathode liquid volumes, relative to the volume of the IRC, may result in high ionic strength in the anode and cathode compartments.

Performance of dBES2 and dBES3 at a Fixed Cell Potential
At a fixed cell potential (e.g., 2.5 V), the biocathode potentials were favorable for electrotrophic methanogenesis (−0.7 V vs Ag/AgCl reference)
As electroactive biofilm matured, the bioanode potentials increased (i.e., became more positive).
Comparison of cyclic voltammetry scans of dBES2 and dBES3 over time indicated a growth in electroactive biofilm at the anode and cathode
Upon startup, the cathode had a low cathode capture efficiency, which was likely due to poor biofilm coverage and/or the use of a pure culture instead of a more robust mixed culture.
Due to the relatively small volume ratio of anolyte and catholyte to electrolyte in the IRC, a rapid increase in IRC initial conductivity from 10 mS/cm to above 50 mS/cm resulted in a disruption to the anode and cathode biofilms. This result may be avoided by adjusting chamber volumes and system architecture.

### CONCLUSIONS

This study demonstrated that using devices and methods as provided herein desalination can be coupled with energy recovery in the form of H₂ or CH₄ production in a BES. In these exemplary systems, higher desalination efficiency and higher CH₄ production was observed when V_{cell} was held constant at 2.5 V, instead of applying a fixed cathode potential. An exemplary system may also be used for the removal of other ions, such as NH₄⁺.

Thus, we have demonstrated organics oxidation, desalination, and H₂/CH₄ biogas recovery as a feasible biotechnological solution to reduce energy requirements for ion removal.

TABLE 1
Experimental conditions for dBES1 feeding
cycles and IRC ion removal for each cycle.

| | Cycle | Initial | IRC Ion | | |
|---|---|---|---|---|---|
| | Length | Conductivity | Removal | Applied Potential | Fixed Potential |
| Cycle | (d) | (mS/cm) | (%) | Method | (Electrode) |
| 1 | 3 | 10.8 | 77 | Fixed cathode | −0.80 vs. Ag/AgCl |
| | | | | potential | (cathode) |
| 2 | 7 | 10.8 | 40 | Fixed cathode | −0.80 vs. Ag/AgCl |
| | | | | potential | (cathode) |
| 3 | 7 | 10.8 | 7 | Fixed cathode | −0.80 vs. Ag/AgCl |
| | | | | potential | (cathode) |
| 4 | 7 | 10.8 | 0 | Fixed cathode | −0.80 vs. Ag/AgCl |
| | | | | potential | (cathode) |
| 5 | 7 | 10.8 | 7 | Fixed cathode | −0.80 vs. Ag/AgCl |
| | | | | potential | (cathode) |
| 6 | 7 | 10.8 | 5 | Fixed cathode | −0.80 vs. Ag/AgCl |
| | | | | potential | (cathode) |
| 7 | 7 | 10.8 | 5 | Fixed cathode | −0.80 vs. Ag/AgCl |
| | | | | potential | (cathode) |
| 8 | 7 | 10.8 | 5 | Fixed cathode | −0.80 vs. Ag/AgCl |
| | | | | potential | (cathode) |
| 9 | 7 | 10.8 | 36 | Fixed cell potential | 2.5 V (cell) |
| 10 | 7 | 10.8 | 35 | Fixed cell potential | 2.5 V (cell) |
| 11 | 7 | 32.0 | 81 | Fixed cell potential | 2.5 V (cell) |

TABLE 2
Cathode capture efficiency (CCE) for
dBES2 and dBES3 over Cycles #1-5

| Cycle | IRC Initial Condition | | dBES2 (%) | dBES3 (%) |
|---|---|---|---|---|
| 1 | 10 | g/L NH₄Cl | 2.7 | 3.2 |
| 2 | 12 | g/L NaCl | 7.0 | 7.3 |
| 3 | 8 | g/L NaCl | 5.7 | 6.2 |
| 4 | 6 | g/L NaCl | 7.8 | 12.2 |
| 5 | 20 | mM phosphate buffer | 9.6 | 9.2 |

### REFERENCES

Dykstra, C. M., Pavlostathis, S. G., 2017 a. Evaluation of gas and carbon transport in a methanogenic bioelectrochemical system (BES). Biotechnology and Bioengineering 114 (5), 961-969.
Dykstra, C. M., Pavlostathis, S. G., 2017 b. Methanogenic biocathode microbial community development and the role of Bacteria. Environmental Science and Technology 51 (9), 5306-5316.
Dykstra, C. M., Pavlostathis, S. G., 2017 c. Zero-valent iron enhances biocathodic carbon dioxide reduction to methane. Environmental Science and Technology 51 (21), 12956-12964.
Dykstra, C. M., Cheng, C., Pavlostathis, S. G., 2020. Comparison of carbon dioxide with anaerobic digester biogas as a methanogenic biocathode feedstock. Environmental Science and Technology, 54 (14), 8949-8957.
Dykstra, C. M., Pavlostathis, S. G., 2021. Hydrogen sulfide affects the performance of a methanogenic bioelectrochemical system for biogas upgrading. Water Research, 200, 117268.

A number of embodiments of the invention have been described. Nevertheless, it can be understood that various modifications may be made without departing from the spirit and scope of the invention. Accordingly, other embodiments are within the scope of the following claims.

What is claimed is:

1. A product of manufacture, a system or an apparatus comprising an anode chamber, an ion removal chamber and a cathode chamber,
wherein the product of manufacture, system or apparatus has an ion removal configuration wherein an anion exchange membrane (AEM) is at an anode interface with the ion removal chamber and a cation exchange membrane (CEM) at a cathode interface with the ion removal chamber resulting in anions selectively flowing or migrating into the anode chamber and cations selectively flowing or migrating into the cathode chamber, thereby concentrating anions in the anode chamber and cations in the cathode chamber,
wherein the anode chamber and the cathode chamber comprises a biological or a microbial community,
wherein optionally the capture of electrons by the plurality of living microbes in the cathode chamber reduces CO₂ to CH₄,
wherein optionally the anode chamber organic compounds are oxidized into biomass and CO₂,
wherein optionally a wastewater flows into the anode chamber and treated water flows out of the anode chamber,
wherein optionally a catholyte is flowed into the cathode chamber and CH₄ biofuel flows out of the cathode chamber,
wherein optionally the product of manufacture, system or apparatus is configured as illustrated in FIG. 1,
wherein optionally the cathode is held at a constant electrical potential, or a substantially constant electrical potential, and the product of manufacture, system or apparatus comprises and is operably linked to (to maintain a substantially constant cathode potential) a potentiostat or any instrument designed to control the working electrode's potential in the electrode electrochemical cell, and a power supply or a photovoltaics device, or the product of manufacture, system or apparatus comprises a connection to an electrical grid to supply power to maintain a substantially constant electrical potential,
and optionally the product of manufacture, system or apparatus runs, or is configured to set to run or operate, at operating voltages comprising:
(i) a cathode potential ranging from between about −0.2 V vs. Ag/AgCl to about −1.5 V vs. Ag/AgCl, optionally having an operating potential of about −0.7 V vs. Ag/AgCl, −0.6 V vs. Ag/AgCl or −0.5 V vs. Ag/AgCl;
(ii) an anode potential ranging from between about 0.0 V vs. Ag/AgCl to about 2.5 V vs. Ag/AgCl, optionally having an operating potential of about 1.2 V vs. Ag/AgCl, 1.1 V vs. Ag/AgCl or 1.3 V vs. Ag/AgCl; and/or
(iii) a cell potential ranging from between about 0.2 V to 5.0 V, optionally having an operating potential of about 2.5 V, 2.4 V, 2.6 V, 2.3 V or 2.7 V.

2. A product of manufacture, a system or an apparatus comprising an anode chamber, an ion collection chamber and a cathode chamber,
wherein the product of manufacture, system or apparatus has an ion removal configuration wherein an anion exchange membrane (AEM) is at a cathode interface with the ion collection chamber and a cation exchange membrane (CEM) at an anode interface with the ion collection chamber resulting in anions and cations selectively flowing or migrating into the ion collection chamber, thereby concentrating ions in the ion collection chamber,
wherein the anode chamber and the cathode chamber comprises a biological or a microbial community,
and optionally the biological or microbial community comprises a plurality of living microbes, and optionally the plurality of living microbes comprise living Bacteria and/or Archaea, and optionally the microbial community comprises methanogenic Bacteria and/or Archaea,
wherein optionally the capture of electrons by the plurality of living microbes in the cathode chamber reduces CO₂ to CH₄,
wherein optionally the anode chamber organic compounds are oxidized into biomass and CO₂,
wherein optionally a wastewater (optionally treated or untreated, or raw or pretreated wastewater, or diluted or undiluted wastewater) flows into the anode chamber and treated water flows out of the anode chamber,
wherein optionally a catholyte is flowed into the cathode chamber and CH₄ biofuel flows out of the cathode chamber,
wherein optionally input for the ion collection chamber comprises brackish water, seawater, saline water or a wastewater (optionally treated or untreated), and output from the ion collection chamber comprises concentrated ions,
wherein optionally the product of manufacture, system or apparatus is configured as illustrated in FIG. 2,
wherein optionally the cathode is held at a constant electrical potential, or a substantially constant electrical potential, and the product of manufacture, system or apparatus comprises and is operably linked to (to maintain a substantially constant cathode potential) a potentiostat, a power supply or photovoltaics device or comprises a connection to an electrical grid to supply power,
and optionally the product of manufacture, system or apparatus runs, or is configured to set to run or operate, at operating voltages comprising:
(i) a cathode potential ranging from between about −0.2 V vs. Ag/AgCl to about −1.5 V vs. Ag/AgCl, optionally having an operating potential of about −0.7 V vs. Ag/AgCl, −0.6 V vs. Ag/AgCl or −0.5 V vs. Ag/AgCl;
(ii) an anode potential ranging from between about 0.0 V vs. Ag/AgCl to about 2.5 V vs. Ag/AgCl, optionally having an operating potential of about 1.2 V vs. Ag/AgCl, 1.1 V vs. Ag/AgCl or 1.3 V vs. Ag/AgCl; and/or
(iii) a cell potential ranging from between about 0.2 V to 5.0 V, optionally having an operating potential of about 2.5 V, 2.4 V, 2.6 V, 2.3 V or 2.7 V.

3. A method for oxidizing raw or pretreated wastewater comprising:
contacting raw or pretreated wastewater with a biological or microbial community in an anode environment using a product of manufacture, system or apparatus as set forth in claim 1,
wherein the biological or microbial community comprises a plurality of living microbes, and optionally the plurality of living microbes comprise Bacteria and/or Archaea,
and biogas or CO₂ is upgraded to generate CH₄ or biofuel in a biocathode and/or the removal of ions in a chamber separated by a membrane(s).

4. A method for oxidizing raw or pretreated wastewater through a biological or microbial community in an anode for the use of chemical reduction in a biocathode and/or the removal of ions in a chamber separated by a membrane(s) comprising:
contacting raw or pretreated wastewater with a biological or microbial community in an anode environment using a product of manufacture, system or apparatus as set forth in claim 1.

5. A method for oxidizing the raw or pretreated wastewater through a biological or microbial community in an anode for the removal of ions in a chamber separated by a membrane(s), comprising:
contacting raw or pretreated wastewater with a biological or microbial community in an anode environment using a product of manufacture, system or apparatus as set forth in claim 1,

6. A method for oxidizing the raw or pretreated wastewater through a biological or microbial community in an anode for the use of biogas upgrading in a biocathode and/or the concentration of ions in a chamber separated by a membrane(s) comprising:
contacting raw or pretreated wastewater with a biological or microbial community in an anode environment using a product of manufacture, system or apparatus as set forth in claim 1,

7. A method for oxidizing the raw or pretreated wastewater through a biological or microbial community in an anode for the concentration of ions in a chamber separated by a membrane(s), comprising:
contacting raw or pretreated wastewater with a biological or microbial community in an anode environment using a product of manufacture, system or apparatus as set forth in claim 1.

8. A method for water deionization and desalination, wherein optionally the water is salt water, comprising:
contacting water to be deionized and desalinated with a biological or microbial community in an anode environment using a product of manufacture, system or apparatus as set forth in claim 1.

9. The method of claim 1, wherein the biological or microbial community comprises a plurality of living microbes.

10. The method of claim 9, wherein the plurality of living microbes comprise living Bacteria and/or Archaea.

11. The method of claim 10, wherein the biological or microbial comprise methanogenic Bacteria and/or methanogenic Archaea.

12. The method of claim 1, wherein input for the ion removal chamber comprises brackish water, seawater, saline water or a treated or untreated wastewater.

13. The method of claim 1, wherein output from the ion removal chamber comprises deionized and/or desalinated water.

14. The method of claim 1, wherein the wastewater comprises treated or untreated wastewater, or comprises raw or pretreated wastewater, or comprises diluted or undiluted wastewater.

15. The method of claim 1, wherein the wastewater flows into the anode chamber and treated water flows out of the anode chamber.
